(19) United States
(12) Patent Application Publication
(10) Pub. No.: US 2007/0164468 A1
(43) Pub. Date: Jul. 19, 2007

(54) Process for producing fibre compositions

(75) Inventors: Johanna Buchert, Espoo (FI); Stina Gronqvist, Tolkkinen (FI); Hannu Mikkonen, Rajamaki (FI); Tarja Oksanen, Espoo (FI); Soili Peltonen, Rajamaki (FI); Anna Suurnakki, Espoo (FI); Liisa Viikari, Helsinki (FI)

Correspondence Address: SUGHRUE MION, PLLC, 2100 PENNSYLVANIA AVENUE, N.W., SUITE 800, WASHINGTON, DC, 20037, US

(73) Assignee: VALTION TEKNILLINEN TUTKIMUSKESKUS, Espoo (FI)

(21) Appl. No.: 10/583,339

(22) PCT Filed: Dec. 23, 2004
(86) PCT No.: PCT/FI04/00794

§ 371 Date: Oct. 2, 2006

(30) Foreign Application Priority Data
Dec. 23, 2003 (FI) 20031902

(51) Int. Cl. B32B 37/00

(52) U.S. Cl. 264/134

(57) ABSTRACT

The present invention concerns a process for producing fibre composites. In particular, the invention provides a novel way of producing biodegradable composites comprising a hydrophobic polymer material and a reinforcing component of fibres derived from plant materials. Composite material produced by means of the present invention has improved strength properties and enhanced adhesion between the bifunctional fibre and the natural or synthetic polymer.

### BACKGROUND OF THE INVENTION

1. Field of the Invention

The present invention relates to a process for modifying the surface properties of a lignocellulosic material. In particular, the present invention concerns a process for producing fibre composites.

2. Description of Related Art

A composite is a synergistic combination of two or more physically distinct materials. The properties of the composite material are superior to those of the individual constituents. Reinforced polymeric composites comprise three main features and elements: the reinforcement, the matrix resin and the interface between them. In conventional composites, these materials involved usually comprise a polymer and fibrous reinforcement consisting of mineral or siliceous materials, such as glass fibres or carbon fibres. These composites have good strength and resistance properties.

However, conventional, fibre reinforced composite products are not readily disposable. Although a biodegradable polymer may be used, the mineral or siliceous material fibre reinforcement makes the material non-biodegradable. There is therefore a need for biodegradable composite materials, in particular composite materials comprising a biodegradable fibrous component. Another important aim is to use renewable fibres and polymers.

There are some basic requirements placed on the various components of a composite. Thus, the matrix has to transfer loads between the reinforcement fibres, it has to protect fibres from aggressive environments, support the fibres in compression, and provide adequate toughness to minimize damage initiation and growth.

Lignocellulose-based materials have been used as fillers, but because of the poor adhesion they have not exhibited enough strength properties. U.S. Pat. No. 610,232 discloses a discontinuous lignocellulose fiber for use as a reinforcing filler for thermoplastic composite compositions. The fiber filler includes a significant percentage by weight of long, “hair-like” fibers. A moldable thermoplastic composite composition including the discontinuous lignocellulose fiber comprises about 20 to about 50 percent by weight of the fiber filler and about 50 to about 80 percent by weight thermoplastic. The discontinuous lignocellulose fiber filler yields thermoplastic composite compositions having improved physical properties over basic thermoplastic.

U.S. Pat. No. 6,368,528 discloses an improved method of making a molded composite article by combining a fibrous material with a binder to form a mixture, drying the mixture to a moisture content of about 6 wt. % to about 14 wt. % based on the weight of the fibrous material to form a mat, coating at least one surface of the mat with an aqueous solution comprising one or more additives selected from the group consisting of: a wetting agent, a mold release agent, a set retarder, and a binder. Thereafter, the mat is consolidated under heat and pressure to form the molded composite article.

Biodegradable plastics and composites from wood are disclosed in U.S. Pat. No. 6,013,774. Materials that completely degrade in the environment far more rapidly than pure synthetic plastics but possess the desirable properties of a thermoplastic: strength, impact resistance, stability to aqueous acid or base, and deformation at higher temperatures. There is provided a method for using the degradable plastic materials in preparing strong, moldable solids. There is further provided a method of making and applications for macromolecular, surface active agents that change the wetting behavior of lignin-containing materials. These surface active agents are used to provide a method of making and applications for synthetic polymers coupled to pieces of a vascular plant using macromolecular surface active agents.

As will appear from the above, wood-based fibres can be used in composites because they are biodegradable. However, the use of wood fibres in composites is not yet possible on a commercial scale, because there are problems related to the poor adhesion between the polymer and the fibre matrix. These are largely caused by the fact that the lignocellulosic matrix is basically hydrophilic and the synthetic or even natural polymer portion of the composite is hydrophobic.

### SUMMARY OF THE INVENTION

It is an aim of the present invention to eliminate the problems of the prior art and to provide a novel way of producing biodegradable composites comprising a first component of a hydrophobic polymer material and a second, reinforcing component of cellulosic or lignocellulosic fibres derived from vegetable materials.

It is a particular aim of the present invention to produce fibres with improved adhesion properties with the polymer in composite materials.

The invention is based on the idea of producing composites of lignocellulosic or cellulosic fibres and hydrophobic polymers by activating the fibres of the matrix with an oxidizing agent capable of oxidizing phenolic groups, modifying the activated surface with a modifying agent, and then compounding the modified fibrous matrix with a natural or—in particular—synthetic polymer. The activation is carried out either enzymatically or chemically by mixing the fibres with an oxidizing agent. The activated fibres are then contacted with a bifunctional agent, such as a monomeric substance, in the following also called a “modifying agent”. This bifunctional agent has at least two functional groups or chemical residues, where the first functional portion provides for binding of the modifying compound to the lignocellulosic fibre material, in particular at the oxidized phenolic groups or corresponding chemical structures of the fibres, which have been oxidized during the activation step. The second chemical portion of the bifunctional agent forms a hydrophobic site on the surface of the material. Such a site is compatible with the hydrophobic material. Thus, once a modified site or “tag” has been formed onto the fibres of the matrix, the surface of the basically hydrophilic fibres is converted into a more hydrophobic form which is more readily compatible with natural and synthetic, hydrophobic polymers.

According to the invention, the tag formed on the fibre provides for good adhesion of the fibre component and the polymer component.

Thus, the present invention provides a process for modifying the surface properties of a lignocellulosic material, comprising the steps of
oxidizing the phenolic or groups having similar structure of the lignocellulosic fibre material to provide an oxidized fibre material,
contacting the oxidized fibre material with a modifying agent containing at least one functional group to provide a lignocellulosic fibre material having a modified surface and
contacting the fibre material with a polymer under conditions allowing for the forming of a composite.

In particular, the phenolic groups of similar groups are oxidized by reacting the lignocellulosic fibre material with a substance capable of catalyzing the oxidation of the groups by an oxidizing agent.

More specifically, the present invention is mainly characterized by what is stated in the characterizing part of claim 1.

The present invention provides important advantages. One of the most important advantages is that the composite material produced by means of the present invention has improved strength properties and enhanced adhesion between the bifunctional fibre and the natural or synthetic polymer. Also other properties necessary for a composite strength, impact resistance, stability to aqueous acid or base, and deformation at higher temperatures are reached at a desirable level by using a fiber that is modified by means of the present invention.

Another advantage is that wood based fibres are biodegradable therefore making the final product where the fibre is used environmentally friendly.

A further advantage is that wood based fibres are readily available.

A further, clear advantage is that the price of wood based fibres is also lower than the reinforcement used in conventional reinforcements.

Further details and advantages of the invention will become apparent from the following detailed description comprising a number of working examples.

### BRIEF DESCRIPTION OF THE DRAWINGS

FIG. 1 depicts graphically the hydrophobicity of TMP pulp treated according to the invention FIG. 1. Hydrophobicity is expressed in terms of contact angle measured after laccase catalysed bonding of isoeugenol (o) and after reference treatment (X)

FIG. 2 depicts graphically the hydrophobicity of TMP pulp treated according to the invention compared to a reference sample. Hydrophobicity is expressed as contact angle measured after laccase catalysed bonding of 3,4,5-trihydroxybenzoic acid dodecyl acid ester (o), after treatment with only 3,4,5-trihydroxybenzoic acid dodecyl acid ester (□) and after reference treatment without any enzyme or 3,4,5-trihydroxybenzoic acid dodecyl acid ester addition (X).

FIG. 3 depicts graphically the hydrophobicity of TMP pulp treated according to the invention. Hydrophobicity is expressed as contact angle measurement after laccase catalysed bonding of 3,4,5-trihydroxybenzoic acid dodecyl acid ester (dodecyl gallate) dispersion.

FIG. 4 depicts in a schematic fashion the effect of enzymatic bonding to kraft pulp on the strength of composite. The figure shows the ultimate tensile strength of injection molded composites containing untreated kraft pulp and polyhydroxybutyrate (PHB) (indicated as REF), kraft pulp containing isoeugenol bonded by enzyme catalysed method (Isoeugenol), and pure PHB without fibre addition (PHB).

### DETAILED DESCRIPTION OF THE INVENTION

As mentioned above, the invention generally relates to a method of producing a fibre composition comprising bioprocessed wood fibres for composite materials. According to the present invention, a new composite product is provided, which comprises a fibre matrix and a hydrophobic agent in the interface between the fibres and the hydrophobic polymer in order to improve adhesion between the fibre and the polymer bound thereto and exhibits good strength properties.

The fibre matrix comprises fibres containing phenolic or similar structural groups, which are capable of being oxidized by suitable enzymes. Such fibres are typically “lignocellulosic” fibre materials, which include fibre made of annual or perennial plants or wooden raw material by, for example, mechanical or chemimechanical pulping. During industrial refining of wood by, e.g., refiner mechanical pulping (RMP), pressurized refiner mechanical pulping (PRMP), thermomechanical pulping (TMP), groundwood (GW) or pressurized groundwood (PGW) or chemithermomechanical pulping (CTMP), a woody raw material, derived from different wood species, is refined into fine fibres in processes which separate the individual fibres from each other. The fibres are typically split between the lamellas along the inter-lamellar lignin layer, leaving a fibre surface, which is at least partly covered with lignin or lignin-compounds having a phenolic basic structure. Such fibres are particularly useful as a matrix for the novel products.

Within the scope of the present invention, also chemical pulps are included if they have a oxidable groups or residual content of lignin sufficient to give at least a minimum amount of phenolic groups necessary for providing binding sites for the modifying agent. Generally, the concentration of lignin in the fibre matrix should be at least 0.1 wt-%, preferably at least about 1.0 wt-%.

In addition to paper and paperboard making pulps of the above kind, also other kinds of fibres of vegetable origin can be used, such as jute, flax and hemp.

In the first stage of the present process, the lignocellulosic fibre material is reacted with a substance capable of catalyzing the oxidation of phenolic or similar structural groups to provide an oxidized fibre material. The substance capable of catalyzing the oxidation is advantageously an enzyme. Typically, the enzymatic reaction is carried out by contacting the lignocellulosic fibre material with an oxidizing agent, which is capable—in the presence of the enzyme—of oxidizing the phenolic groups to provide an oxidized fibre material. Such oxidizing agents are selected from the group of oxygen and oxygen-containing gases, such as air, and hydrogen peroxide. These can be supplied by various means, such as efficient mixing, foaming, gas enriched with oxygen or oxygen supplied by enzymatic or chemical means or chemicals releasing oxygen or peroxides to the solution. Hydrogen peroxide can be added or produced in situ.

According to another embodiment, the lignocellulosic fibre material is reacted with a chemical oxidizing agent capable of catalyzing the oxidation of phenolic or similar structural groups to provide an oxidized fibre material in the first stage of the process. The chemical oxidizing agent may be a typical, free radical forming substance, an organic or inorganic oxidizing agent. Examples of such substances are hydrogen peroxide, Fenton reagent, organic peroxide, peroxo acids, persulphates, potassium permanganate, ozone and chloride dioxide. Examples of suitable salts are inorganic transition metal salts, specifically salts of sulphuric acid, nitric acid and hydrochloric acid. Ferric chloride is an example of suitable salts. Strong chemical oxidants such as alkali metal- and ammoniumpersulphates and organic and inorganic peroxides can be used as oxidising agents in the first stage of the present process. According to an embodiment of the invention, the chemical oxidants capable of oxidation of phenolic groups are selected from the group of compounds reacting by radical mechanism.

According to another embodiment, the lignocellulosic fibre material is reacted with a radical forming radiation capable of catalyzing the oxidation of phenolic or similar structural groups to provide an oxidized fibre material Radical forming radiation comprises gamma radiation, electron beam radiation or any high energy radiation capable of forming radicals in a lignocellulose or lignin containing material.

According to an embodiment of the invention, the oxidative enzymes capable of catalyzing oxidation of phenolic groups) are selected from, e.g. the group of phenoloxidases (E.C.1.10.3.2 benzenediol:oxygen oxidoreductase) and catalyzing the oxidation of o- and p-substituted phenolic hydroxyl and amino/amine groups in monomeric and polymeric aromatic compounds. The oxidative reaction leads to the formation of phenoxy radicals and. Another group of enzymes, comprise the peroxidases and other oxidases. “Peroxidases” are enzymes, which catalyze oxidative reaction using hydrogen peroxide as their electron aceptor, whereas “oxidases” are enzymes, which catalyze oxidative reactions using molecular oxygen as their electron acceptor.

In the method of the present invention, the enzyme used may be for example laccase, tyrosinase, peroxidase or other oxidases, in particular, the enzyme is selected the group of laccases (EC 1.10.3.2), catechol oxidases (EC 1.10.3.1), tyrosinases (EC 1.14.18.1), bilirubin oxidases (EC 1.3.3.5), horseradish peroxidase (EC 1.11.1.7), manganase peroxidase (EC1.11.1.13) and lignin peroxidase (EC 1.11.1.14).

The amount of the enzyme is selected depending on the activity of the individual enzyme and the desired effect on the fibre. Advantageously, the enzyme is employed in an amount of 0.0001 to 10 mg protein/g of dry matter.

Different dosages can be used, but advantageously about 1 to 100,000 nkat/g, preferably 10-500 nkat/g.

The activation treatment is carried out at a temperature in the range of 5 to 90° C., typically about 10 to 85° C. Normally, ambient temperature (room temperature) or a slightly elevated temperature (20-80° C.) is preferred. The pH is 2-12 and consistency 0.5-95%.

In the chemical activation method, fibres are treated with chemical oxidizing agents, such as ammonium-, sodium- or potassium persulphate. Different dosages can be used, typically about 5-95% as solids of fibre amount. The activation treatment is carried out at a temperature in the range of 5 to 90° C., typically about 10 to 85° C. Normally, ambient temperature (room temperature) or a slightly elevated temperature (20-80° C.) is preferred.

In the second step of the process, a modifying agent is bonded to the oxidized phenolic groups of the matrix to provide binding surfaces for the hydrophobic component of the composite, viz. the thermoplastic or thermosetting polymer. Such a modifying agent typically exhibits at least two functional sites, a first functional site, which is capable of contacting and binding with the oxidized phenolic group or to its vicinity, and a second hydrophobic site or a hydrocarbon chain or a site for linking the hydrophobic agent, which is compatible with a hydrophobic polymer. The term “bifunctional” is used to designate any compound having at least two functional groups or chemical structures capable of achieving the above aims. The functionalities of the first group include reactive groups, such as hydroxyl (including phenolic hydroxy groups), carboxy, anhydride, aldehyde, ketone, amino, amine, amide, imine, imidine and derivatives and salts thereof, to mention some examples. The second group provides for hydrophobicity or a site for linking the hydrofobing agent, and it typically comprises an aliphatic, saturated or unsaturated, linear or branched hydrocarbon chain having at least 1 carbon atom, preferably 2 to 24 carbon atoms As an example, the various derivatives of ferulate can be mentioned, namely eugenol and isoeugenol and their alkyl derivatives, such as methyleugenol and methyl-isoeugenol. Another example is constituted by the alkyl derivatives of gallate (esters of 3,4,5-trihydroxybenzoic acid), such as propyl gallate, octanyl gallate and dodecyl gallate. All of these comprise at least one functional group, which bonds to the oxidized lignocellulosic matrix, and a hydrocarbon tail, which is saturated or unsaturated. Typically, the hydrocarbon tail contains a minimum of two, preferably at least three carbon atoms, and extends to up to 30 carbon atoms, in particular 24 carbon atoms. Such chains can be the residues of fatty acids bonded to the core of the modifying agent. As mentioned above, the hydrophobic tail can be utilized for the preparation of composites comprising a hydrophobic polymer, which is reinforced with fibres of plant origin.

The first and second functional and hydrophobic sites (functional groups/hydrocarbon chains) can be attached to a residue, which can be a linear or branched aliphatic, cycloaliphatic, heteroaliphatic, aromatic or heteroaromatic. According to one preferred embodiment, aromatic compounds having 1 to 3 aromatic ring(s) are used. Thus, in the above examples, the residue, to which the first and second groups are attached, comprises an aromatic residue. Oftentimes, the first and the second sites are located at para-positions with respect to each other, in case of aromatic compounds having a single aromatic nucleus.

The modifying agent can comprise a plurality of first functional groups and of second hydrophobic structures. In the gallate compounds there are three phenolic hydroxyl groups, one or several of which may take part in the bonding of the compound to the oxidized phenolic structure of the fibre matrix.

According to an embodiment of the invention, the modifying agent is activated with an oxidizing agent. The oxidizing agent may be same or different as the oxidizing agent used for the activation of the fibre material.

The modifying agent can be added as such or in the form of a dispersion. The dispersion may be prepared immediately prior to the reaction or well in advance.

It is essential that modifying agent is bonded chemically or by chemi- or physisorption to the fibre matrix to such an extent that at least an essential part of it cannot be removed. One criterion, which can be applied to test this feature, is washing in aqueous medium, because often the fibrous matrix will be processed in aqueous environment, and it is important that it retains the new and valuable properties even after such processing. Thus, preferably, at least 10 mole-%, in particular at least 20 mole-%, and preferably at least 30 mole-%, of the modifying agent remains attached to the matrix after washing or leaching in an aqueous medium.

Depending on the modifying agent or its precursor, the pH of the medium can be neutral or weakly alkaline or acidic (pH typically about 2 to 12). It is preferred to avoid strongly alkaline or acidic conditions because they can cause hydrolyzation of the fibrous matrix. Normal pressure (ambient pressure) is also preferred, although it is possible to carry out the process under reduced or elevated pressure in pressure resistant equipment. Generally, the consistency of the fibrous material is about 0.5-95% by weight during the contacting stage.

According to one embodiment, the first and second stages of the process may be carried out in sequence. According to another embodiment, the first and second stages are carried out simultaneously.

In the third stage of the process, the fibre material having a modified, hydrophobic surface is contacted with a polymer under conditions allowing for intimate contacting between the modified fibre and the polymer to form a composite. For this, specific dispersion techniques may be used. The contacting can take place in a mould or in a conventional press under heat (e.g. at a temperature close to or even above the melting point of the polymer component) and pressure (typically 1 to 20 bar).

Conventional composites include a thermoset resin matrix or a matrix comprising a thermoplastic polymer. Examples of thermoset include epoxy or polyester polymers. Thermoset resins are inherently brittle, and are formed by a chemical reaction and as such cannot be remelted or reformed once set. By contrast, thermoplastics, such as polyethylene, including HD-polyethylene, LD-polyethylene, MD-polyethylene and blends thereof, polypropylene, polyurethanes, TP-elastomers, polyesters, including PET, POM, and polystyrene, are tough and can be remelted. Also biopolymers, such as polylactide, polyhydroxybuturate or polyvalerate of their mixtures can be used find use in composites.

The above reaction and contacting steps can be carried out sequentially or simultaneously.

The composite products can be used in several areas. They are used in consumer and food products, and different industries such as the automotive industry. The product may be processed by methods know in the field of polymer technology, e.g. by moulding, including injection moulding. Polymers can be also used in multilayer packaging materials as structural or barrier materials, which are produced by layering technique.

### EXAMPLES

### Example 1

Preparation of Dispersions

Dispersions useful in the present invention can be prepared as disclosed in

FI Patent No. 105566 and the corresponding U.S. Pat. No. 6,780,903;

FI Patent No. 113874 and the corresponding published International Patent Application No. WO 04/029097; and

FI Patent No. 108038 and the corresponding U.S. Pat. No. 6,656,984, the contents of which are herewith incorporated by reference.

Experimentally, dispersions I to VI were prepared in the following manner:

I. Preparation of DoGa Dispersion (I)

2.0 g gallic acid dodecyl alcohol ester (DoGa) was dissolved in 100 ml of 1:1 acetone-water mixture. After that 0.2 g POLYSALZ S (BASF Ag) dispersant was added. Then the solution was diluted with 150 m of water. During the dilution process the substrate formed a white colloidal precipitate. The mixture was then heated to 90-100° C. During the heating period acetone evaporated and the precipitate turned to a homogeneous dispersion. Finally 0.1 g lecithin was added and the dispersion was left to cool down. The formed dispersion was stabile.

II. Preparation of DoGa Dispersion (II)

2.0 g DoGa was dissolved in 36 ml acetone and 0.5 g of gyseroltriacetate (triacetin) was added. After that 100 ml water containing 0.2 g Tween 81 was added. The mixture was heated to 90° C. and mixed. During the heating period the mixture turned to pale dispersion and the acetone evaporated. The formed dispersion is stabile in the temperature range of 45-90° C.

III. Preparation of Poly(L-Lactic Acid):DoGa Dispersion

45.0 g poly(L-lactic acid) prepared by the method described in WO 96/01863 and U.S. Pat. No. 6,087,456, 5.0 g Doga, 6.0 g 40-88 Mowiol (Clariant GmbH), 35.0 g water and 35 g glycerol triacetate (triacetin) were combined and mixed 1-2 h at 90-100° C. in a glass reactor. During the heating period the reaction mixture turned to a white paste-like viscous dispersion. After heating period the paste was diluted with water first at 70-90° C. and then temperature bellow 30° C. to the water concentration of 50%.

IV. Preparation of poly(3-hydroxybutyrate-co-valerate) Dispersion

50.0 g of poly(3-hydroxybutyrate-co-valerate)polymer, BIOPOL PHBV12 (Monsanto Europe S.A) 40 g triacetin, 12 g 40-88 Mowiol (Clariant GmbH) and 35 g of water were mixed in glass reactor.

The reaction mixture was heated and mixed 2-6 h at 100° C. During the heating period the reaction mixture turned on pale highly viscous paste After that the paste was diluted with water first at 70-90° C. and finally at the temperature bellow 30° C. to the water content of 50% of the dispersion.

V. Preparation of BIOPOL PHB Dispersion

100. g of poly(3-hydroxybutyrate-co-valerate)polymer, BIOPOL PHBV12 (Monsanto Europe S.A) 80 g 1:1 mol mixture of triethylcitrate: n-octenyl-succinic-acid anhydride (OSA), 20 g 8-88 Mowiol (Clariant GmbH) and 50 g of water were mixed in glass reactor. The reaction mixture was heated and mixed 4 h at 100° C. During the heating period the reaction mixture turned on pale highly viscous paste. After that the paste was diluted with water first at 70-90° C. and finally at the temperature bellow 30° C. to the water content of 50% of the dispersion. The formed viscous dispersion is stable in storage and can be easily mixed with aqueous TMP pulps.

Examples 2 to 6 illustrate the forming of a hydrophobic surface on a lignocellulosic matrix, and Example 7 discloses a specific embodiment of a fiber/polymer composite.

### Example 2

Chemical Bonding of DoGa Dispersion to TMP.

2.0 g 3,4,5-trihydroxy benzoic acid dodecyl alcohol ester was dissolved in 100 ml 1:1 vol/vol acetone:water mixture. After that 0.2 g Polysalz(S) (BASF)(polyacrylic acid) dispersion agent was dissolved in the mixture. After that 200 ml water containing 0.1 g lecitin was added. The mixture was heated to 60-80° C. and mixed. Acetone was evaporated at elevated temperature. During the heating period the reaction mixture turned on whitish dispersion. 50 g of TMP was mixed with water and the pulp consistency was adjusted to 5% at 20° C. 60° C. DoGa dispersion was mixed with pulp. Thereafter 1.5 g ammoniumpersulfate (APS) dissolved in water was added and reaction continued 60 min. After that the pulp was filtered twice and washed with 400 ml water. The hydrophobicity of the handsheets prepared from the pulp as analysed by contact angle measurement was increased significantly by APS oxidative bonding of 3,4,5-trihydroxy benzoic acid dodecyl alcohol ester dispersion to TMP compared with the reference pulp (oxidation of pulp with APS).

### Example 3

Chemical Bonding of Poly(Lactic Acid):DoGa Dispersion to TMP

50 g of TMP pulp was diluted with water to 5% consistency. 10 g of poly(lactic acid):3,4,5-trihydroxy benzoic acid dodecyl alcohol ester dispersion prepared as described above was mixed with the pulp. Immediately after that 0.5 g of ammonium persulfate dissolved in water was added. Reaction was continued for 60 min. After that, the pulp was diluted with water in 2000 ml volume, filtered twice an washed with 0.4 ml water. The hydrophobicity of the handsheets prepared from the pulp analysed by contact angle measurement was increased significantly by APS oxidative bonding of poly(lactic acid):3,4,5-trihydroxy benzoic acid dodecyl alcohol ester: dispersion to TMP compared with the reference treated pulp (oxidation of pulp with APS).

### Example 4

Enzymatic Bonding of Isoeugenol to TMP Matrix

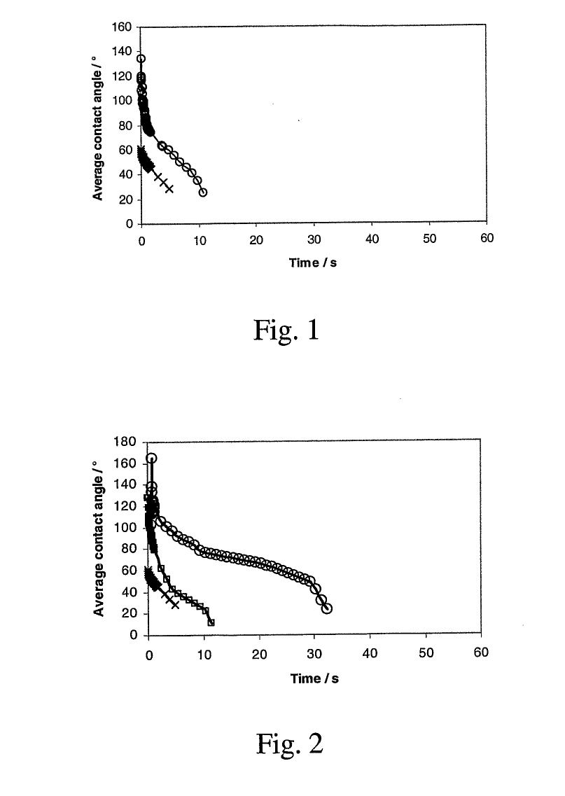

A 100 g portion of spruce TMP was suspended in water. The pH of the suspension was adjusted to pH 4.5 by addition of acid. The suspension was stirred at 40° C. Laccase dosage was 1000 nkat/g of pulp dry matter and the final pulp consistency was 4%. After 30 minutes laccase reaction, 0.12 mmol isoeugenol/g of pulp dry matter was added to the pulp suspension. After 2 h total reaction time, the pulp suspension was filtered and the pulp was washed thoroughly with water. For comparison purposes, a reference treatment was carried out using the same procedure as described above but without addition of laccase or isoeugenol. The hydrophobicity of the handsheets prepared from pulp analysed by contact angle measurement was increased by laccase catalysed bonding of isoeugenol as compared with the reference treated pulp (FIG. 1).

### Example 5

Enzymatic Bonding of Dodecyl Gallate to TMP

A 100 g portion of spruce TMP was suspended in water. The pH of the suspension was adjusted to pH 4.5 by addition of acid. The suspension was stirred at 40° C. Laccase dosage was 1000 nkat/g of pulp dry matter and the final pulp consistency was 4%. After 30 minutes laccase reaction, 0.12 mmol 3,4,5-trihydroxybenzoic acid dodecyl acid ester/g of pulp dry matter was added to the pulp suspension. After 2 h total reaction time the pulp suspension was filtered and the pulp was washed thoroughly with water. For comparison purposes, a reference treatment was carried out using the same procedure as described above but without addition of laccase and 3,4,5-trihydroxybenzoic acid dodecyl acid ester or only laccase. The hydrophobicity of the handsheet prepared from pulp analysed by contact angle measurement was increased by laccase catalysed bonding of 3,4,5-trihydroxybenzoic acid dodecyl acid ester to TMP as compared with the reference treated pulps (FIG. 2).

### Example 6

Enzymatic Bonding of Dodecyl Gallate Dispersion to TMP Matrix

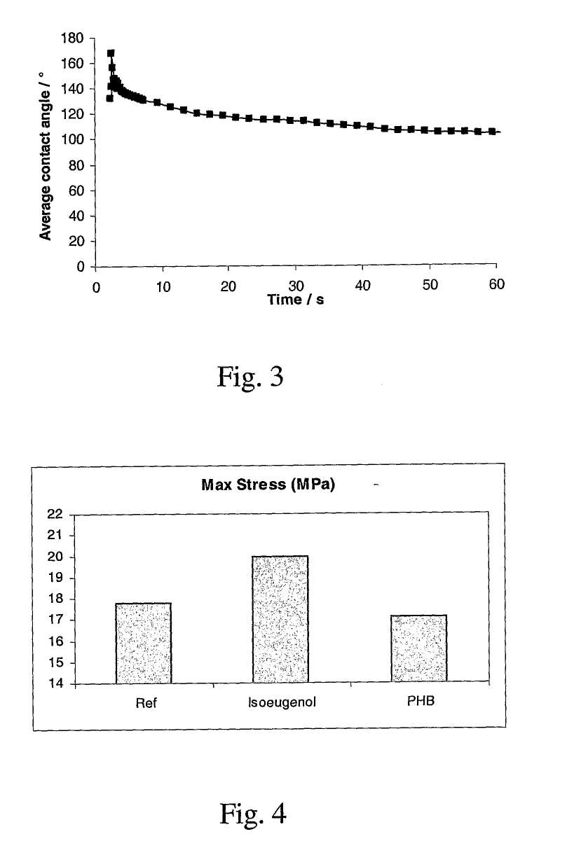

A 100 g portion of spruce TMP was suspended in water. The pH of the suspension was adjusted to pH 4.5 by addition of acid. The suspension was stirred at 40° C. Laccase dosage was 1000 nkat/g of pulp dry matter and the final pulp consistency was 4%. After 30 minutes laccase reaction, 0.12 mmol 3,4,5-trihydroxybenzoic acid dodecyl acid ester dispersion/g of pulp dry matter was added to the pulp suspension. After 2 h total reaction time the pulp suspension was filtered and the pulp was washed thoroughly with water. The hydrophobicity of the handsheet prepared from pulp analysed by contact angle measurement was high after laccase catalysed bonding of 3,4,5-trihydroxybenzoic acid dodecyl acid ester dispersion to TMP (FIG. 3).

### Example 7

Compatibility of Hydrophobiced Fibres with Polymers

Softwood kraft pulp was hydrophobised as explained in Example 4 using isoeugenol as a bonded component. The hydrophobic fibre material was thereafter compounded with polyhydroxybutyrate (PHB) used as a matrix and injection molded to test specimens. Reference test specimens with untreated fibres were also injection molded. From the results in FIG. 4 it can be seen that composite strength is increased by addition of hydrophobised kraft pulp as compared with composite with reference kraft pulp and pure PHB composite. Thus, it can be stated that specific enzyme catalysed bonding of hydrophobic compound, here isoeugenol, to fibre material increases the compatibility of fibre material with organic polymer such as PHB. Similar results can be obtained when using inorganic polymer as a matrix with fibre material hydrophobised with enzyme catalysed method.

The above results demonstrate that it is possible to increase the compatibility of the lignocellulosic material with polymers in production of composite materials by increasing the hydrophobicity of lignocellulosic material (in this case wood fibre pulp) significantly by bonding a hydrophobic agent onto the fibre material. Similar results were obtained with peroxidases.

1. A process for producing a composite comprising a lignocellulosic fibrous matrix, having phenolic groups, and a hydrophobic polymer, said process comprising the steps of
a) oxidizing the phenolic groups or the groups having a similar structure to provide an oxidized fibre material,
b) contacting the oxidized fibre material with a modifying agent containing at least one first functional portion, which is compatible with the oxidized fibre material, and at least one second hydrophobic portion, which is compatible with the hydrophobic polymer, to provide a lignocellulosic fibre material having a modified surface, and
c) contacting the fibre material with the hydrophobic polymer under conditions allowing for intimate contacting between the modified fibre and the polymer to form a composite.

2. The process according to claim 1, wherein the lignocellulosic fibrous matrix is reacted with an oxidizing agent in the presence of a substance capable of catalyzing the oxidation of phenolic groups by said oxidizing agent.

3. The process according to claim 1, wherein the modifying agent is activated with an oxidizing agent.

4. The process according to claim 1, wherein the reaction of step (a) is carried out in aqueous phase at a consistency of about 0.1 to 95% by weight of the fibre material.

5. The process according to claim 1, wherein the modifying agent comprises a hydrocarbon chain, which is compatible with the hydrophobic polymer.

6. The process according claim 1, wherein the second portion of the modifying agent comprises an aliphatic, saturated or unsaturated, linear or branched hydrocarbon chain having at least 1 carbon atom, preferably 2 to 24 carbon atoms.

7. The process according claim, wherein the first functional group is selected from the group of hydroxy, carboxy, anhydride, aldehyde, ketone, amine, amide, imine, imidine and derivatives and salts thereof.

8. The process according to claim 1, wherein the modifying agent comprises a plurality of first functional groups.

9. The process according to claim 1, wherein the modifying agent comprises at least one phenolic group.

10. The process according to claim 1, wherein the modifying agent comprises at least one compound selected from eugenol, isoeugenol and their alkyl derivatives, and alkyl derivatives of gallate.

11. The process according to claim 1, wherein the modifying agent is added in the form of a dispersion or as such.

12. The process according to claim 1, wherein the substance capable of catalyzing the oxidation of phenolic groups by said oxidizing agent is an enzyme.

13. The process according to claim 1, wherein the modifying agent is reacted with an oxidizing agent in the presence of an enzyme capable of catalyzing the oxidation of the phenolic groups.

14. The process according to claim 10, wherein the lignocellulosic fibre material and the modifying agent are mixed together in water to form an aqueous slurry having a consistency of 0.1 weight-% or more, and the oxidizing agent and the enzyme are added to the slurry.

15. The process according to claim 1, wherein the enzyme capable of catalyzing the oxidation of phenolic groups is selected from the group of peroxidases and oxidases.

16. The process according to claim 15, wherein the enzyme is selected the group of laccases (EC 1.10.3.2), catechol oxidases (EC 1.10.3.1), tyrosinases (EC 1.14.18.1), bilirubin oxidases (EC 1.3.3.5), horseradish peroxidase, manganase peroxidase (EC 1.11.1.13), lignin peroxidase (EC 1.11.1.14)

17. The process according to claim 15, wherein the enzyme dosage is 1 to 100,000 nkat/g, preferably 10-500 nkat/g, and it is employed in an amount of 0.0001 to 10 mg protein/g of dry matter.

18. The process according to claim 1, wherein the oxidizing agent is selected from the group of oxygen and oxygen-containing gases, such as air, and hydrogen peroxide.

19. The process according to claim 18, wherein oxygen or oxygen-containing gas is actively introduced into the aqueous slurry during the reaction.

20. The process according to claim 2, wherein the substance capable of catalyzing the oxidation of phenolic groups is hydrogen peroxide, Fenton reagent, organic peroxidase, potassium permanganate, ozone and chlorine dioxide, persulphate or an inorganic transition metal salt.

21. The process according to claim 1, wherein radical forming radiation capable of catalyzing the oxidation of phenolic or similar structural groups is used to provide an oxidized fibre material.

22. The process according to claim 1 any of the preceding claims, wherein the reaction steps are carried out sequentially or simultaneously.
